(19) United States
(12) Patent Application Publication
(10) Pub. No.: US 2010/0200556 A1
(43) Pub. Date: Aug. 12, 2010

(54) DEVICE FOR HEATING AN AIR FLOW

(75) Inventors: Erwan Gogmos, Puteaux (FR); Christophe Schmittheisler, Epfig (FR); Mathieu Mougey, Ensisheim (FR); Pascal Miss, Selestat (FR); Michel Brun, Rustenhart (FR); Stephane Weingaertner, Pfaffenheim (FR); Nicolas Robin, Mulhouse (FR); Geoffrey Denny, Rixheim (FR); Gerard Eckerlen, Rouffach (FR)

Correspondence Address: FOLEY AND LARDNER LLP;SUITE 500, 3000 K STREET NW, WASHINGTON, DC, 20007, US

(73) Assignee: Behr France Rouffach SAS

(21) Appl. No.: 12/367,006

(22) Filed: Feb. 6, 2009

(51) Int. Cl. B60H 1/22; H05B 1/02; H05B 3/42

(52) U.S. Cl. 219/202; 165/42; 219/544

(57) ABSTRACT

The invention relates to a device for heating an air flow, in particular for a motor vehicle, comprising a frame which extends substantially in a plane, at least one heating section, which is held on the frame and which can be traversed by a first, heatable partial air flow, with an electrical heating element, in particular PTC element, and with at least one flow resistance element which is arranged in the plane adjacent to the heating section and which is held on the frame and which can be traversed by a second, non-heatable partial air flow, wherein a flow means is provided on the device, by means of which flow means the two partial air flows are mixed downstream of the device.

### CROSS-REFERENCE TO RELATED PATENT APPLICATIONS

The right of foreign priority is claimed under 35 U.S.C. §119(a) based on European Application No. 08290052.3, filed Feb. 8, 2008, the entire contents of which, including the specification, drawings, claims and abstract, are incorporated herein by reference.

### BACKGROUND

The invention relates to a device for heating an air flow, in particular for a motor vehicle.

EP 1 621 378 A1 describes an electrical heating device for a motor vehicle, in which electrical heating device an electrical PTC heating element is provided adjacent to a flow resistance element, which is embodied as a grille, in a frame. Webs of the frame which extend in each case in the air flow direction are situated between the grille and the heating element, by means of which webs an air flow through the flow resistance element is separated from an air flow through the heating element.

### SUMMARY OF PREFERRED EMBODIMENTS

It is an object of the invention to specify a device for heating an air flow in which a homogeneously heated air flow is present at as short a distance as possible downstream of the device.

According to a preferred embodiment the invention, said object is achieved, for a device specified in the introduction, by means of the characterizing features of claim 1. By way of the flow means, the two partial air flows, of which the first is heated to a high temperature by the heating element and the second is not heated in the region of the flow resistance element, are at least partially merged and mixed. In this way, the temperature of the air flow is homogenized over a cross section of the air duct only a short distance downstream of the device. This is advantageous for example if an outflow of the air into a passenger compartment takes place directly downstream of the heating element, such that local jets of hot air are avoided. In the case of branching taking place into a plurality of air ducts which, for structural reasons, are arranged a short distance downstream of the device, the flow means according to the preferred embodiments of the invention ensure that all the branch ducts are supplied with the same air temperature.

It is generally advantageous that the heating section comprises a thermally conducting fin, in particular a corrugated fin, to increase its surface area. The fin may, for optimum thermal connection, be arranged on a contact plate of the electrical heating element. In the case of this design in particular, it is possible for heating sections to be provided for example as standard parts or else as pre-assembled modules for different air ducts or forms and frame dimensions.

In one preferred embodiment of the invention, the flow means is designed such that the fin adjoins the flow resistance element in the plane, without a guide web of the frame being provided between the fin and the flow resistance element. As a result of the omission of the web which is provided in each case adjacent to a fin in EP 1 621 378 Al, it is possible for mixing between the adjacent partial air flows to take place even in the plane of the heating sections. Turbulence often occurs in particular in the region of the fins, which turbulence promotes such mixing in the transverse direction.

In another embodiment of the invention, which may be provided either as an alternative or in addition to the first embodiment, the flow means is designed as a guide structure which acts on at least one of the partial flows in the transverse direction. Such a guide structure, which is provided as an addition in relation to the prior art, generates particularly effective mixing of the partial flows. In one cost-effective detail design, the guide structure is formed here in a materially integral fashion with the frame. The frame may, for example, be a plastic part, in particular an injection-molded part, made for example of polyamide. In this way, it is possible in particular for the frame to have a shape which is adapted to the individual application in the vehicle, and the heating sections are formed as unitary components which may be combined with a multiplicity of different frames.

In one possible detail design, the guide structure is arranged at the outlet side of the device, such that at least one of the outflowing air flows is provided with a transverse component or else turbulence.

In one variant, the guide structure may be arranged in the region of the heating element and in particular deflect the heated first partial air flow in the direction of the second partial air flow. Alternatively or additionally, the guide structure may also be arranged in the region of the flow resistance element and in particular deflect the second partial air flow in the direction of the heated first partial air flow.

In a further alternative or additional variant, the guide structure is formed integrally with the flow resistance element or is arranged substantially in a plane with the flow resistance element. In this way, it is possible for the overall length of the device in the flow direction of the air to be kept small. An integral design with the flow resistance element may, for example, be provided in that the flow resistance element has inclined lamellae, by means of which a transverse component of the second partial flow can be obtained.

### BRIEF DESCRIPTION OF THE DRAWINGS

Further objects, features and advantages of the present invention will become apparent from the detailed description of preferred embodiments that follows, when considered together with the accompanying figures of drawing.

FIG. 1 shows a schematic illustration of a heating device according to the prior art.

FIG. 2 shows a schematic illustration of a first embodiment of the invention.

FIG. 3 shows a partial depiction of the embodiment according to FIG. 2.

FIG. 4 shows a schematic illustration of a second embodiment of the invention.

FIG. 5 shows a schematic illustration of a third embodiment of the invention.

FIG. 6 shows a schematic illustration of a fourth embodiment of the invention.

### DETAILED DESCRIPTION OF THE PREFERRED EMBODIMENTS

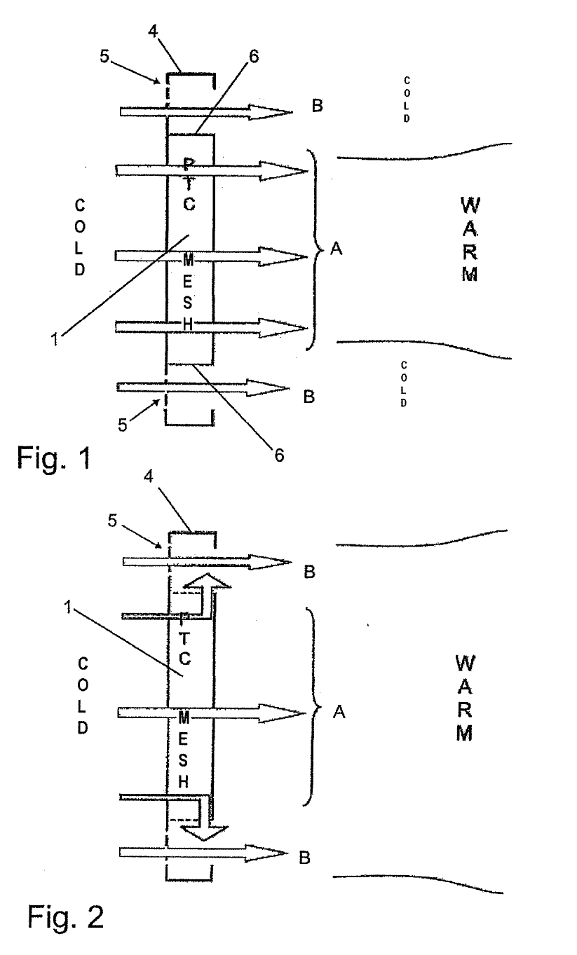

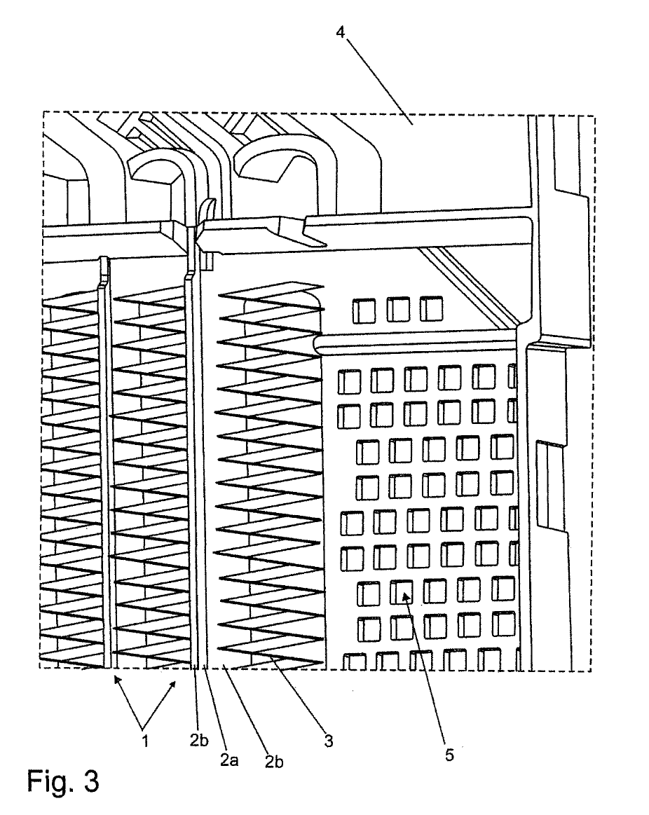

In the device illustrated in FIG. 1, which device is known from the prior art, in particular from document EP 1 621 378 A1, a plurality of heating sections 1, in each case one PTC heating element 2 (PTC=Positive Temperature Coefficient) with corrugated fins 3 (see FIG. 3) arranged thereon, are held in a plastic frame 4 composed of polyamide. The individual heating sections are constructed in the same way as in the cited prior art, and comprise PTC elements 2a which are held between elongate contact plates 2b, with the corrugated fins being fixed to the contact plates 2b from the outside.

The device is a heating element in an air-conditioning system of a motor vehicle.

The frame extends in a plane perpendicular to FIG. 1, with the device having a considerably smaller extent in the flow direction of the air (horizontal direction in FIG. 1) than in the plane.

In said plane, flow resistance elements 5 are provided adjacent to the heating sections 1, which flow resistance elements 5 are formed, in the manner of a grille, in a materially integral fashion with the frame 4. The flow resistance elements 5 serve to ensure a sufficient pressure drop across the device to heat a sufficient proportion of air at the heating sections 1.

The device therefore divides all of the throughflowing air into a first partial air flow A, which traverses the heating sections 1 and is heated, and a second partial air flow B, which traverses the flow resistance elements 5 and is not heated. Here, in the prior art, guide webs 6 of the frame 4 are provided between the heating sections 1 and the flow resistance elements 5, which guide webs 6 prevent mixing of the partial air flows A, B.

In a first embodiment of the invention, depicted by way of example in FIG. 2 and FIG. 3, it is provided that said guide webs 6 are not to be provided, such that the partial air flows A, B directly adjoin one another without separation in the edge region of the corrugated fins 3. Intensive mixing of the two partial air flows is generated in this way. Depending on the design of the grille or flow resistance elements 5, it is possible for a relatively low dynamic pressure to be present downstream of said elements, such that, as in the schematic illustration according to FIG. 2, a partial transverse flow of the first partial flow A into the second partial flow B takes place. Such a transverse flow is also assisted by the heat-induced expansion of the air of the partial flow A.

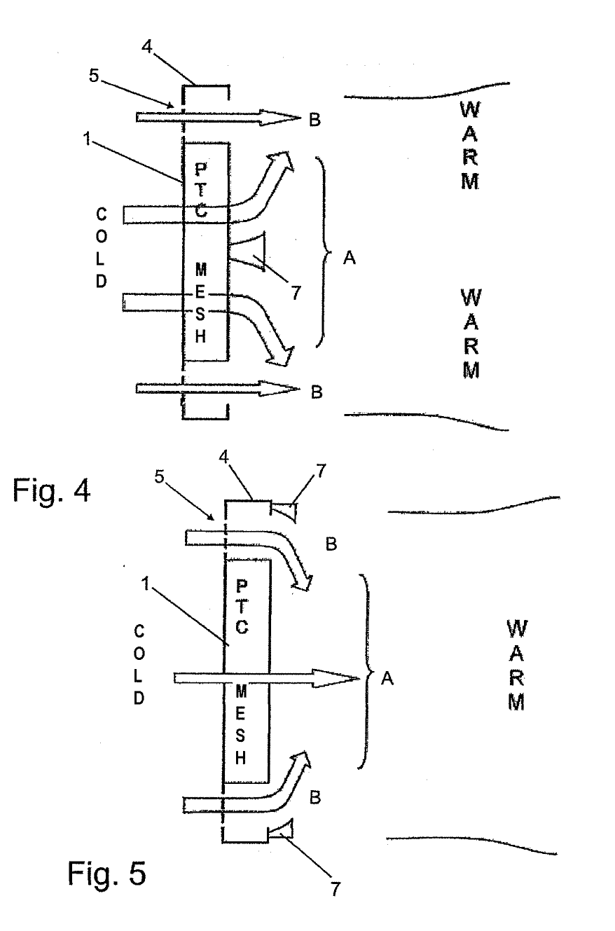

In a further alternative or additional embodiment of the invention depicted by way of example in FIG. 4, a guide structure 7 which is formed in a materially integral manner with the plastic frame 4 is provided, for example in the manner of aligned lamellae, downstream of the mesh of heating sections 1. As a result of the guide structure 7, a part of the first partial flow A is acted on with a transverse component, such that effective mixing of the partial air flows A, B takes place only a short distance downstream of the device.

In a further alternative or additional embodiment depicted by way of example in FIG. 5, the guide structure 7 is provided at the outlet side in the region of the flow resistance elements 5. Similarly to the example in FIG. 4, the second partial flow B is hereby acted on with a transverse component, such that said second partial flow B mixes with the first partial flow A a short distance downstream of the device.

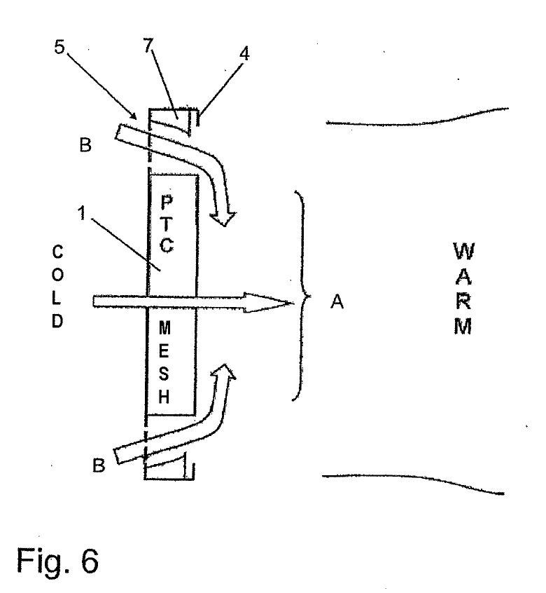

In a further alternative or additional embodiment depicted by way of example in FIG. 6, the guide structure 7 is arranged substantially in the same plane as the heating sections 1, as a result of which the structural length of the device in the longitudinal direction can be kept small. Such a guide structure may for example be formed integrally with the flow resistance elements 5, for example in the form of lamellae.

It is self-evident that the individual features of the different exemplary embodiments may be expediently combined with one another depending on requirements.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. A device for heating an air flow, comprising
a frame which extends substantially in a plane,
at least one heating section, which is held on the frame and which can be traversed by a first, heatable partial air flow, with an electrical heating element, and with at least one flow resistance element which is arranged in the plane adjacent to the heating section and which is held on the frame and which can be traversed by a second, non-heatable partial air flow, and
a flow structure configured to mix the two partial air flows downstream of the device.

2. The device as claimed in claim 1, wherein the heating section comprises a thermally conducting fin, in particular a corrugated fin.

3. The device as claimed in claim 2, wherein the fin is arranged on a contact plate of the electrical heating element.

4. The device as claimed in claim 2, wherein the flow structure is configured such that the fin adjoins the flow resistance element in the plane, without a guide web of the frame being provided between the fin and the flow resistance element.

5. The device as claimed in claim 1, wherein the flow structure is a guide structure which acts on at least one of the partial flows in the transverse direction.

6. The device as claimed in claim 5, wherein the guide structure is formed in a materially integral fashion with the frame.

7. The device as claimed in claim 5, wherein the guide structure is arranged at an outlet side of the device.

8. The device as claimed claim 5, wherein the guide structure is arranged in the region of the heating section and in particular deflects the heated first partial air flow in the direction of the second partial air flow.

9. The device as claimed in claim 5, wherein the guide structure is arranged in the region of the flow resistance element and in particular deflects the second partial air flow (B) in the direction of the heated first partial air flow.

10. The device as claimed in one of claim 5, wherein the guide structure is formed integrally with the flow resistance element or is arranged substantially in a plane with the flow resistance element.

11. The device as claimed in claim 1, wherein the electrical heating element comprises a PTC element.

12. A motor vehicle comprising the device for heating an air flow according to claim 1.
